(19) United States
(12) Patent Application Publication
(10) Pub. No.: US 2015/0293828 A1
(43) Pub. Date: Oct. 15, 2015

(54) TESTING APPARATUS, TESTING SYSTEM AND TESTING METHOD THEREOF

(71) Applicant: Chun-Yi Lu, Taipei City (TW)

(72) Inventor: Chun-Yi Lu, Taipei City (TW)

(21) Appl. No.: 14/332,401

(22) Filed: Jul. 16, 2014

(30) Foreign Application Priority Data
Apr. 14, 2014 (TW) 103113560

(51) Int. Cl. G06F 11/263; G06F 11/22

(52) U.S. Cl. CPC G06F 11/2635; G06F 11/2205

(57) ABSTRACT

A testing apparatus, a testing system and a testing method thereof are provided. The testing apparatus is used to test at least one electronic apparatus. The testing apparatus includes a testing data transceiver and a processor. The testing data transceiver is coupled to functional circuits of the at least one electronic apparatus through connection interfaces and transports several testing data correspondingly to the functional circuits for testing the functional circuits to obtain several corresponding data. The processor receives the corresponding data and determines a product group of the at least one electronic apparatus according to the corresponding data.

### CROSS-REFERENCE TO RELATED APPLICATION

This application claims the priority benefit of Taiwan application serial no. 103113560, filed on Apr. 14, 2014. The entirety of the above-mentioned patent application is hereby incorporated by reference herein and made a part of this specification.

### BACKGROUND

1. Field of the Invention

The invention is directed to a testing apparatus and a testing system and more particularly, to a testing apparatus, a testing system and testing method thereof for a system-level electronic product.

2. Description of Related Art

In the related art, testing data which is typically called as test patterns are utilized in an IC automated validation process for placing a single or multiple chips in a package. However, such testing method is not imported with a process for testing system-level electronic apparatuses (e.g., computers, servers, tablet computers, mobile phones, game consoles, cameras and so on).

Meanwhile, in the testing method for system-level electronic apparatuses of the related art, essential electrical characteristics (an open circuit, a short circuit, a voltage and a current values) of individual functional circuit in an electronic apparatus are measured, and whether the individual functional circuit is good or damaged is determined according to the measured results. However, system functions generated by a plurality of functional circuits can not be tested.

Additionally, in a development process of an electronic product, each individual signal is measured for each of the functional circuits through a single function setting in the testing technique of the related art, and accordingly, whether signals generated by the functional circuits comply with relevant standards are determined. Nevertheless, no capabilities of emulating the signals for determining compatibility of the functional circuits nor the capability for abnormal signal processing are provided by the related art.

In current techniques, whether mass production is feasible for the products is determined according to probability or proportion of occurrence of errors by testing a great amount of end products including permutations and combinations of actual software modules and hardware specifications provided by manufacturers in strict environmental conditions (e.g., temperatures or humidities) in the development process of the system-level electronic apparatuses. In this way, whether all the permutations and combinations are verified cannot be guaranteed, and such testing method leads to not only consumption in time and labor but also a great amount of end products in need, which is less environmentally friendly and inefficient. More importantly, the testing environments for the development process do not necessarily match the situations of mass production in the future, and as a result, the consistency in quality can be difficulty ensured under conditions of limited cost and quantity.

### SUMMARY

The invention provides a testing apparatus, a testing system and a testing method thereof which are used to test at least one system-level electronic apparatus and obtain a product group of the electronic apparatus under test.

The invention is directed to a testing apparatus used to test at least one electronic apparatus. The testing apparatus includes a testing data transceiver and a processor. The testing data transceiver is coupled to a plurality of functional circuits of the at least one electronic apparatus through a plurality of connection interfaces and respectively transports a plurality of testing data correspondingly to the functional circuits for testing the functional circuits to generate a plurality of corresponding data. The processor is coupled to the testing data transceiver, transports the testing data to the testing data transceiver and receiving the corresponding data from the testing data transceiver and determines at least one product group of the at least one electronic apparatus and at least one of the functional circuits according to the corresponding data.

In an embodiment of the invention, the testing apparatus further includes a memory device. The memory is coupled to the processor and used to store at least one of the testing data, the corresponding data and the at least one product group corresponding to the functional circuits.

In an embodiment of the invention, the testing apparatus receives the testing data through an external apparatus and stores the testing data into the memory device.

In an embodiment of the invention, the testing data transceiver respectively transports the testing data to the corresponding functional circuits, receives a plurality of testing response data respectively generated in response by the functional circuits according to each of the corresponding testing data and the testing data transceiver transports the testing response data to the processor and respectively determines the testing results corresponding to the functional circuits.

In an embodiment of the invention, the processor determines a level corresponding to each of the functional circuits according to corresponding data and further determines the product group of the at least one electronic apparatus according to the levels of the functional circuits.

In an embodiment of the invention, the testing apparatus is embedded in the at least one electronic apparatus.

In an embodiment of the invention, the processor emulates the testing data transceiver as an application electronic device of one of the functional circuits through sending a command and performs a test on one of the functional circuits through the emulated testing data transceiver.

In an embodiment of the invention, the functional circuits include a network transmission circuit, a display interface circuit, an audio interface circuit, a power control circuit, a touch circuit, an image capture circuit, a data storage circuit and a transmission interface circuit.

The invention is directed to a testing system including a plurality of electronic apparatuses and a testing apparatus. Each of the electronic apparatuses has a plurality of functional circuits. The testing apparatus includes a testing data transceiver and a processor. The testing data transceiver is coupled to a plurality of functional circuits of the at least one electronic apparatus through a plurality of connection interfaces and respectively transports a plurality of testing data correspondingly to the functional circuits for testing the functional circuits to generate a plurality of corresponding data. The processor is coupled to the testing data transceiver, transports the testing data to the testing data transceiver for the testing data transceiver to receive the corresponding data and determines at least one product group of the at least one electronic apparatus and at least one of the functional circuits according to the corresponding data.

The invention is directed to a testing method which is used to test at least one electronic apparatus. The testing method comprising: respectively transporting a plurality of testing data corresponding to a plurality of functional circuits of the at least one electronic apparatus for respectively testing the functional circuits to generate a plurality of corresponding data; and, receiving the corresponding data and determining at least one product group of the at least one electronic apparatus and at least one of the functional circuits according to the testing result.

To sum up, in the invention, a single testing apparatus is configured to perform an integrated test on system-level electronic apparatuses. Through the testing apparatus of the invention, the test performed on the system-level electronic apparatuses can be quickly completed to speed up the production process. Meanwhile, through the testing apparatus of the invention, a state of each of the functional circuits in the electronic apparatus can be obtained so as to complete a detection of operation status on an electronic product. On the other hand, through the testing apparatus of the invention, a product group (or product grade) of each electronic apparatus can be further determined, and adaptive peripheral circuits (or devices) can be selectively applied to the electronic apparatuses, so that the electronic apparatuses can better optimize the functionalities (or performance).

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a testing apparatus according to an embodiment of the invention.

FIG. 2 is a schematic diagram showing a testing apparatus according to another embodiment of the invention.

FIG. 3 is a schematic diagram showing a testing apparatus according to yet another embodiment of the invention.

FIG. 4 is a schematic diagram showing a testing apparatus according to still another embodiment of the invention.

FIG. 5A and FIG. 5B schematically illustrate a method for obtaining the testing data according to the embodiments of the invention.

FIG. 6 is a schematic diagram showing a testing system according to the embodiments of the invention.

FIG. 7A and FIG. 7B is a schematic diagram showing a method for the testing data to test according to the embodiments of the invention.

### DESCRIPTION OF EMBODIMENTS

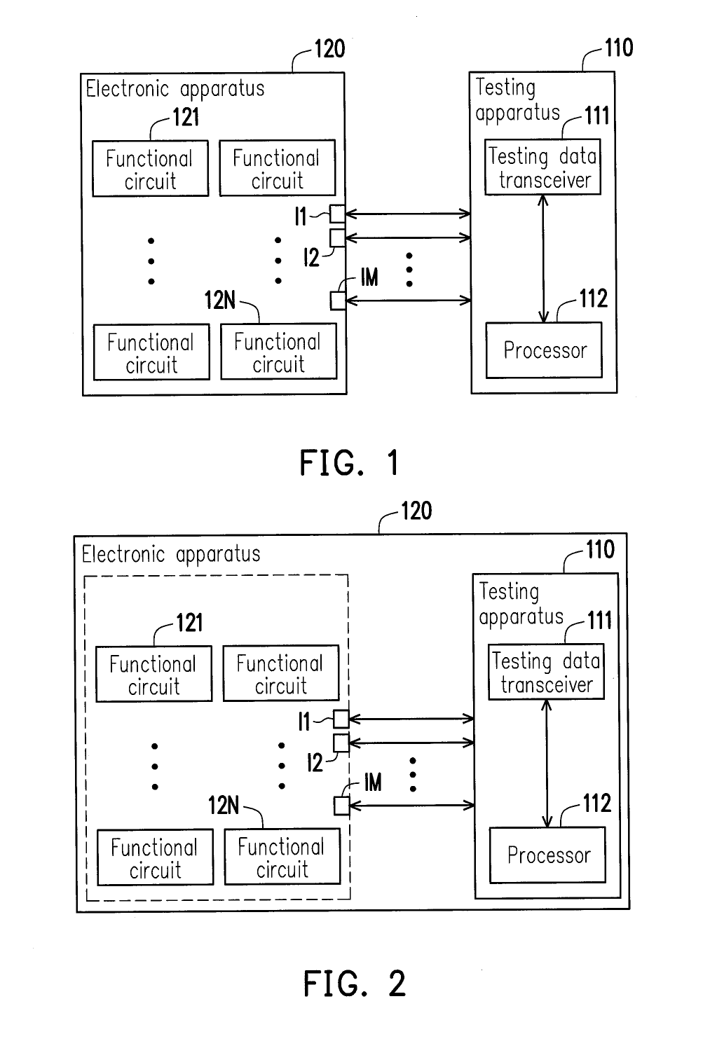

Referring to FIG. 1, FIG. 1 is a schematic diagram showing a testing apparatus according to an embodiment of the invention. Referring to FIG. 1, a testing apparatus 110 is coupled to an electronic apparatus 120. The electronic apparatus 120 has a plurality of functional circuits 121 to 12N. The electronic apparatus 120 is a system-level electronic apparatus, and each of the functional circuits 121 to 12N may be a circuit formed by chip, a combination of chips and one or more passive components or a combination of one or more passive components.

The functional circuits 121 to 12N may be configured on one or more circuit boards in the electronic apparatus 120. Types of the circuit boards are no limited to certain types in the present embodiment. To be specific, the circuit boards in the electronic apparatus 120 may be rigid printed circuit boards, flexible printed circuit boards or a combination thereof.

The testing apparatus 110 includes a testing data transceiver 111 and a processor 112. The testing data transceiver and the processor are coupled with each other. The testing data transceiver 111 is coupled to the functional circuits 121 to 12N of the electronic apparatus 120 through a plurality of connection interfaces I1 to IM. The testing data transceiver 111 respectively transports a plurality of testing data correspondingly to the functional circuits 121 to 12N through the connection interfaces I1 to IM for testing the functional circuits 121 through 12N. After receiving the corresponding testing data (which may include data and/or commands for testing), each of the functional circuits 121 to 12N generates a plurality of corresponding data according to the received testing data and returns the corresponding data to the testing data transceiver 111. Wherein, the corresponding data may be a plurality of testing results.

In this case, the testing data may be test patterns which are commonly used to perform a circuit probe (CP) test or a final test (FT) on an integrated circuit.

In the present embodiment, the testing apparatus 110 is sited outside the electronic apparatus 120 under test, and the connection interfaces I1 to IM correspond to the functional circuits 121 to 12N in a one-to-one, a many-to-one or a one-to-many manner. For instance, when the functional circuit 121 is a network transmission circuit, its corresponding connection interface I1 may be an RJ45 interface.

The processor 112 receives corresponding data returned from the functional circuits 121 to 12N through the testing data transceiver 111. The processor 112 then analyzes according to the received corresponding data to determine a product group of the electronic apparatus 120 under test. It should be noted that in addition to determining whether the corresponding functional circuit are bad or good according to the corresponding data, the processor 112 of the present embodiment of the invention may compare the corresponding data according to a plurality of testing standards with a plurality of levels and determine the product group of each functional circuit according to the compared results. The processor 112 may further determine the product group of each electronic apparatus 120 under test according to a distribution of the corresponding data of all the functional circuits 121 to 12N.

For instance, taking the functional circuit 121 served as a power supply for example, when the processor 112 receives a corresponding data (e.g., a power source generated by the power supply) returned by the functional circuit 121, the processor 112 may determine a speed of voltage rise, an accuracy and a stability of the power source so as to determine the product group of the functional circuit 121. The product group may be grouping according to product level. Certainly, the product level may also include a level for the functional circuit 121 in case being a damaged bad product.

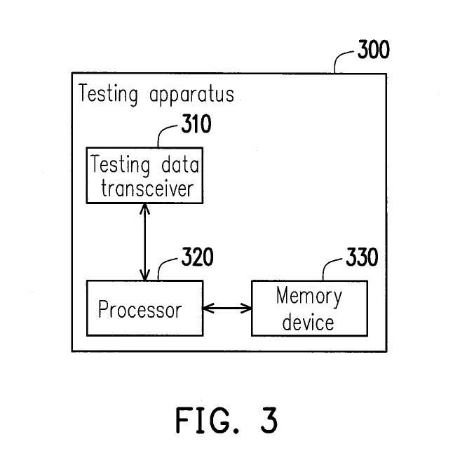

Referring to FIG. 2, FIG. 2 is a schematic diagram showing a testing apparatus according to another embodiment of the invention. In FIG. 2, the testing apparatus 110 is embedded in the electronic apparatus 120. In this case, the testing apparatus 110 together with at least one of the functional circuits 121 to 12N may be disposed on the same circuit board. Certainly, the testing apparatus 110 may also be solely disposed on a circuit board without any one of the functional circuits 121 to 12N disposed. Based on the structure where the testing apparatus 110 is embedded in the electronic apparatus 120, the connection interfaces I1 to IM may be wire connected with welding spots on the circuit board of the testing apparatus 110 through welding spots on the circuit board of the functional circuits 121 to 12N. Certainly, the connection interfaces I1 to IM may also be formed by disposing pins on the circuit board. To be more specific, the signal connection interfaces that are well known to the persons with ordinary skill of the art may be used as the connection interfaces I1 to IM, and the connection interfaces I1 to IM are not limited to certain types in the embodiments of the invention.

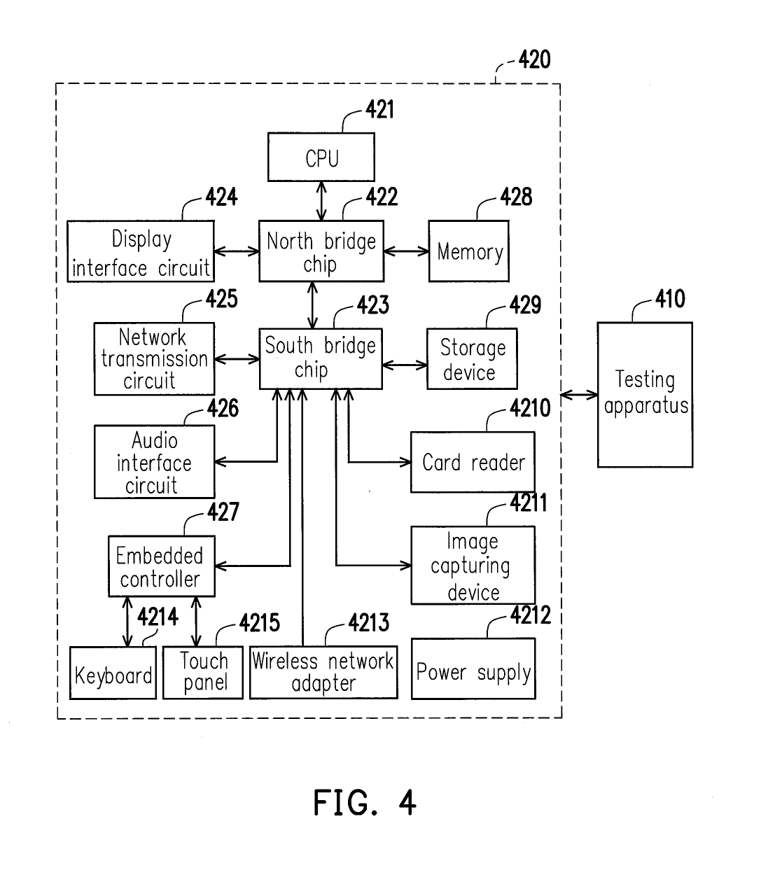

Referring to FIG. 3, FIG. 3 is a schematic diagram showing a testing apparatus according to yet another embodiment of the invention. A testing apparatus 300 includes a testing data transceiver 310, a processor 320 and a memory device 330. Differing from the preceding embodiment, the testing apparatus 300 further includes the memory device 330. The memory device 330 is coupled to the processor 320 and used to store testing data of functional circuits corresponding to electronic apparatuses under test. When the testing apparatus 300 performs a test on an electronic apparatus, the processor 320 reads the testing data from the memory device 330 according which functional circuit is to be tested. Meanwhile, the processor 320 transports the read testing data to the functional circuit under test through the testing data transceiver 310 for testing. In response, the functional circuit under test provides testing response data to the testing data transceiver 310 according to the received testing data. The processor 320 receives the testing response data through the testing data transceiver 310 and determines a product group of the functional circuit under test accordingly.

On the other hand, the memory device 330 may also store a plurality of testing standards with a plurality levels corresponding to the functional circuits. When determining the product group of the functional circuit under test, the processor 320 may read a corresponding multi-level testing standard from the memory device 330 and obtain a product group of the functional circuit under test by comparing the testing response data with the testing standard.

Since a system-level electronic apparatus has a plurality of functional circuits, the functional circuits have various product groups, respectively. The processor 320 may further determine an overall product group of the electronic apparatus according to a distribution of the product groups of the functional circuits. For instance, if a number of the functional circuits having an A level (i.e., the best level) take a proportion over a predetermined proportion of the functional circuits, the processor 320 may determine that the product group of the electronic apparatus is A. In contrary, if a number of the functional circuits having a C level (i.e., the worst level) take a proportion over another predetermined proportion of the functional circuits, the processor 320 may determine that the product group of the electronic apparatus is C. Thereby, sales end may sell the electronic apparatuses with different product groups to the market in different price levels to achieve a goal of best use of the electronic apparatuses.

Certainly, the processor 320 may output the product group of each functional circuit, such that engineers may acquire a state of each functional circuit transported from the processor 320. Thereby, the engineers who are in charge of manufacturing or repairing can fix or replace the malfunctioning circuits, and sales persons can equip corresponding application electronic devices for the electronic apparatuses according to the product group of each functional circuit, such that the electronic apparatuses can be operated more stably to improve feasibility of product shipments.

It should be additionally mentioned that when the testing apparatus 300 performs the test on one of the functional circuits, the processor 320 may emulate the testing apparatus 300 as an application electronic device corresponding to the functional circuit under test. For instance, when the functional circuit under test is a network transmission circuit, the testing apparatus 300 may be correspondingly emulated as an electronic apparatus, such as a switching machine or a router.

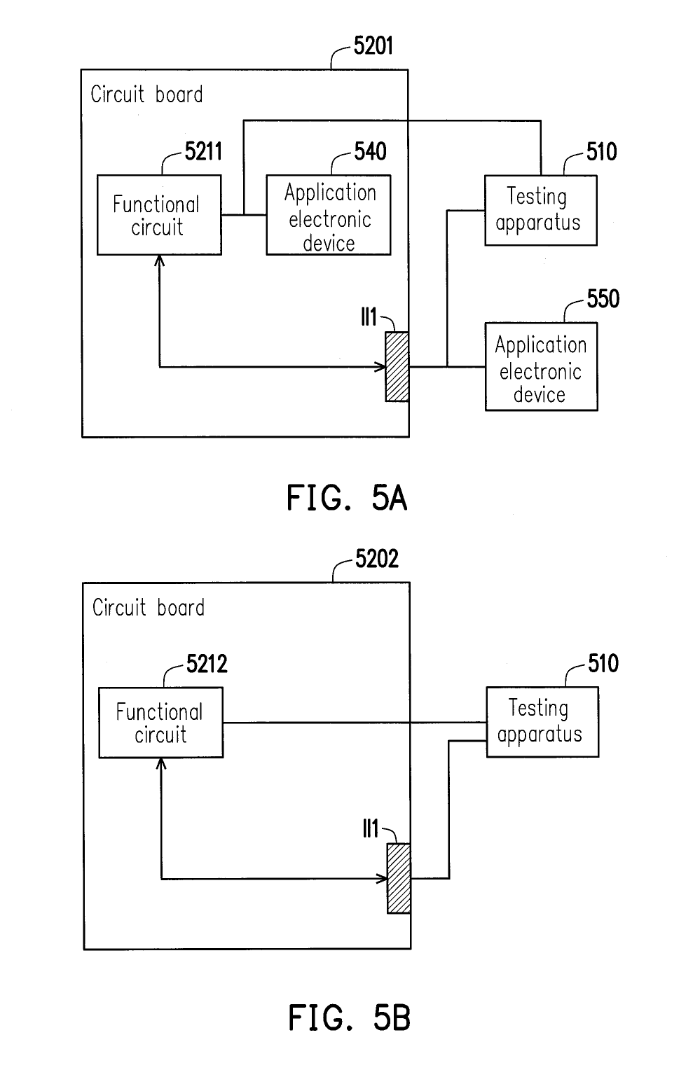

Referring to FIG. 4, FIG. 4 is a schematic diagram showing a testing apparatus according to still another embodiment of the invention. A testing apparatus 410 is used to test an electronic apparatus 420. The electronic apparatus 420 is, for example, a desktop computer system. The electronic apparatus 420 includes a plurality of functional circuits, such as a central processing unit (CPU) 421, a north bridge chip 422, a south bridge chip 423, a display interface circuit 424, a network transmission circuit 425, an audio interface circuit 426, an embedded controller 427, a memory 428, a storage device 429, a card reader 4210, an image capturing device 4211, a power supply 4212, a wireless network adapter 4213, a keyboard 4214 and a touch panel 4215. Therein, any two or three of the CPU 421, the north bridge chip 422 and the south bridge chip 423 may be integrated as a chip for implementation. The testing apparatus 410 may be coupled to the functional circuits through connection interfaces and respectively transports a plurality of testing data correspondingly to the functional circuits for testing the functional circuits.

It should also be mentioned that the functional circuits may be correspondingly added with a plurality of application electronic devices. For example, the display interface circuit 424 may correspond to a display, and the network transmission circuit 425 may correspond to a router for network transmission.

In the present embodiment, the testing apparatus 410 may perform the test on the functional circuits sequentially or simultaneously. In this case, the testing apparatus 410 may store testing data corresponding to each of the functional circuits and may even further store testing data corresponding to functional circuits of different manufacturers in advance. Meanwhile, the testing data may be provided corresponding to different testing conditions, such as testing data provided in a high-voltage operation versus testing data provided in a low-voltage operation or alternatively, testing data provided in a high-temperature environment versus testing data provided in a low-temperature environment. Thereby, the testing apparatus 410 may perform a variety of tests on the electronic apparatus 420 so as to achieve precise classification based on the product groups.

Additionally, the functional circuit may also include other functional circuits that may be included a system-level electronic apparatuses, such as a touch circuit, an image capture circuit and so on.

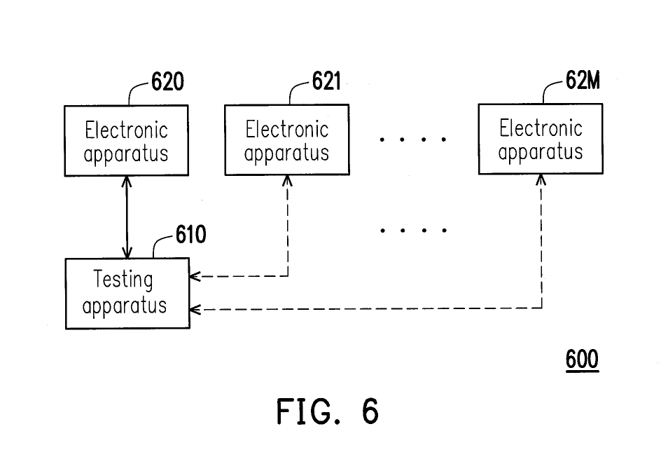

Referring to FIG. 5A and FIG. 5B, FIG. 5A and FIG. 5B schematically illustrate a method for obtaining the testing data according to the embodiments of the invention. In FIG. 5A, a functional circuit 5211 on a circuit board 5201 is connected with a corresponding application electronic device 550 through a connection interface M. Alternatively, the application electronic device 540 corresponding to the functional circuit 5211 may be disposed on the circuit board 5201 and connected with the functional circuit 5211 through the wiring or metal trace on the circuit board 5201. The testing apparatus 510 is coupled to application electronic devices 540 and 550 and coupled to a path to the functional circuit 5211.

When the application electronic devices 540 and 550 transmit signals to the functional circuit 5211 for a test, the testing apparatus 510 may retrieve information transported by the application electronic devices 540 and 550 and may record the information for being served as testing data. When the test performed on the application electronic devices 540 and 550 are completed, the testing apparatus 510 also stores corresponding testing data, and referring to FIG. 5B, the testing apparatus 510 is emulated as at least one of the application electronic devices 540 and 550 for testing another functional circuit 5212 on a circuit board 5202. Certainly, the functional circuits 5212 and 5211 have the same function.

The aforementioned method for obtaining the testing data is merely an example. In other embodiments of the invention, the testing data may be written into the testing apparatus through a wired or a wireless manner. Alternatively, in the present embodiment, the testing data may also be written into a non-volatile memory device which is disposed in the testing apparatus 510.

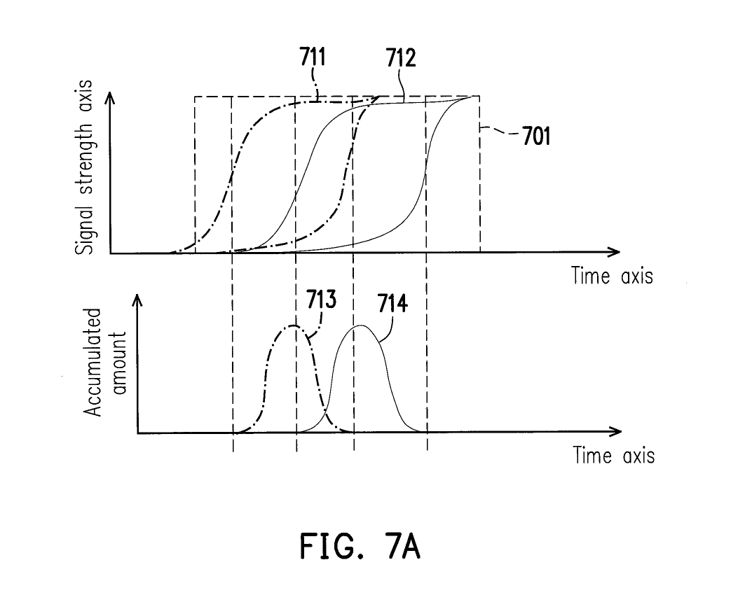

Referring to FIG. 6, FIG. 6 is a schematic diagram showing a testing system according to the embodiments of the invention. A testing system 600 includes a testing apparatus 610 and a plurality of electronic apparatuses 620 to 62M. The testing apparatus 610 may be disposed in a manner of the testing apparatuses described in the preceding embodiments. When the electronic apparatuses 620 to 62M are tested, the electronic apparatuses 620 to 62M may be sequentially or simultaneously coupled to the testing apparatus 610 for a test. The testing apparatus 610 may then reply the product groups of the electronic apparatus under test and the product group of each of the functional circuits, which are served as important bases for a tester to analyze, apply or sell electronic products 620 to 62M.

In light of the foregoing, the invention provides a testing apparatus for testing system-level electronic apparatus. With the testing apparatus of the invention, a level of an electronic apparatus under test can be determined.

Additionally, it is to be noted that according to the embodiments of the invention, a margin test operation and a full scan operation may be further performed to test various standards for each of the functional circuits. Regarding the margin test, for example, if it is assumed that an operation voltage range of the functional circuits is to be tested, the testing standard may be set as a predetermined testing voltage range, e.g., 3V to 7V. When the margin test is performed, the testing voltage range may be enlarged to a range from 2V to 8V, for example. Thus, a maximum workable operation voltage range of a functional circuit under test is obtained through a test, and a product group of the functional circuit under test is set according to the maximum workable operation voltage range.

In a full scan operation, the testing range is divided into a plurality of testing steps and the functional circuit is tested step by step. Through the full scan operation, the quality of the functional circuit under test can be analyzed more precisely so as to obtain dynamic electric states of an electrical signal, such as a setup time, a hold time, a rising time and a falling time.

Certainly, the testing method may also be used to perform other types of testing items on the functional circuit under test, such as an operation temperature, a voltage level, a current level, transient change of voltage, which are well known test contents to the persons with ordinary skills of the art, and will not be repeatedly hereinafter.

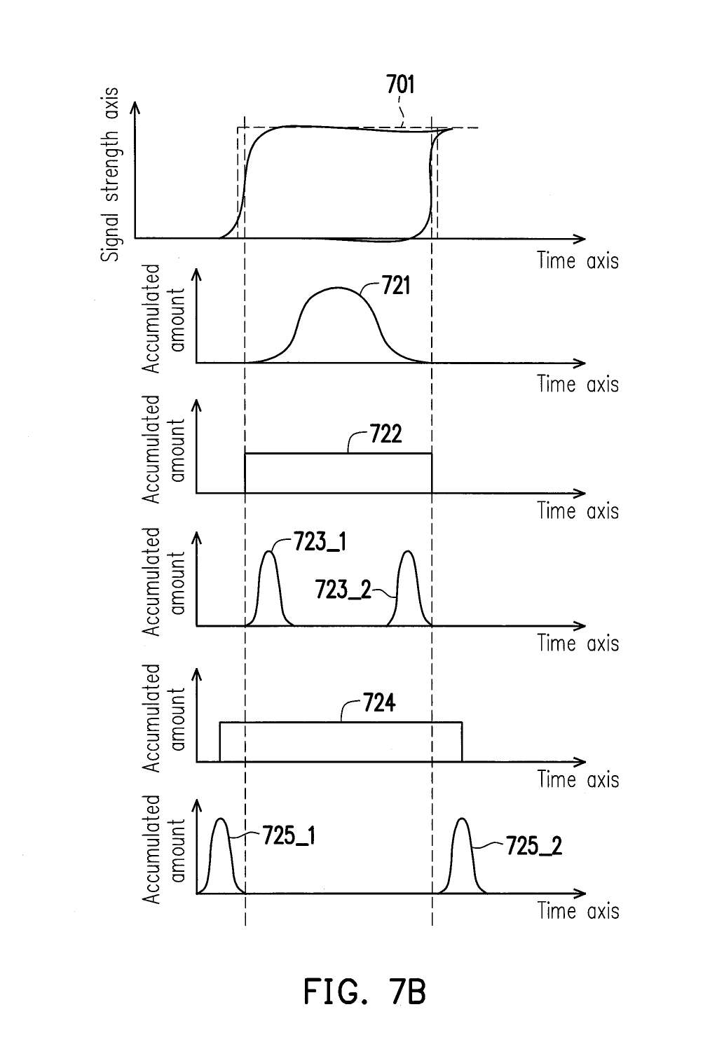

For instance, Referring to FIG. 7A and FIG. 7B hereinafter, FIG. 7A and FIG. 7B is a schematic diagram showing a method for the testing data to test according to the embodiments of the invention. Areas 711 and 712 respectively illustrate relationships between signal strengths of electrical signals of functional circuits of different manufacturers (e.g., Manufacturers A and B) and time. Areas 711 and 712 are mostly within a standard range 701. In specific, when a test is performed on a plurality of functional circuits of Manufacturer A, waveforms of the electrical signals under test may be distributed in the area 711. When the test is performed on a plurality of functional circuits of Manufacturer B, waveforms of the electrical signals under test may be distributed in the area 712.

Additionally, a curve 713 represents an accumulated amount of rising events occurring in the signal strengths of the electrical signals replied by the functional circuits of Manufacturer A. Additionally, a curve 714 represents an accumulated amount of rising events occurring in the signal strengths of the electrical signals replied by the functional circuits of Manufacturer B. In the testing system of the invention, the curves 713 and 714 may be obtained according corresponding data, and difference between product groups of the functional circuits under test of Manufacturers A and B may be determined according to the distributions presented by the curves 713 and 714. In FIG. 7A, both the curves 713 and 714 present normal distributions, which show that the functional circuits under test of both Manufactures A and B are normal.

Referring to FIG. 7B, the test is performed on the functional circuits of a single manufacturer, where various types of test may be performed on a functional circuit under test to obtain curves 721, 722, 723_1, 723_2, 724, 725_1 and 725_2 representing accumulated amounts of different states, and detailed states of the functional circuit under test can be obtained according to distribution states presented by the curves 721, 722, 723_1, 723_2, 724, 725_1 and 725_2. Therein, the curve 721 presents a normal distribution, the curve 722 presents an average distribution, the curves 723_1 and 723_2 present distributions of results obtained by performing a boundary test on two boundaries of the standard range 701, the curve 724 presents a distribution of results obtained by performing a margin test having a range larger than the standard range 701 on the functional circuit under test, and the curves 725_1 and 725_2 present distributions of results obtained by performing an abnormal test having a range out of the standard range 701 on the functional circuit under test.

According to FIG. 7A and FIG. 7B, in the embodiments of the invention, the test may be performed on the functional circuit under test may be tested at different time points, and based on the distributions presented with respect to the electrical signals within and out of the standard range, performance of the functional circuit can be determined, such that the product group can be determined more precisely.

Certainly, the embodiments of the invention may not be limited to analyzing the testing states of the functional circuits at different times, and the analysis may also be performed based on the testing states of the functional circuits under test and other types of physical measurements (e.g., operation temperatures, operation voltages, operation currents) to obtain more information related to electrical characteristics of the functional circuits under test.

Moreover, the testing system of the invention may further stimulate to send different noise injections or jitter injections, pulse signals, or even generate signals not within the standard range (which have different strengths or maximum and minimum limits) to verify a noise processing capability or processed results of abnormal signals of a system.

What is claimed is:

1. A testing apparatus, used to test at least one electronic apparatus, comprising:
a testing data transceiver, coupled to a plurality of functional circuits of the at least one electronic apparatus through a plurality of connection interfaces and respectively transporting a plurality of testing data corresponding to the functional circuits respectively for testing the functional circuits to generate a plurality of corresponding data; and
a processor, coupled to the testing data transceiver, transporting the testing data to the testing data transceiver for the testing data transceiver to receive the corresponding data and determining at least one product group of the at least one electronic apparatus and at least one of the functional circuits according to the corresponding data.

2. The testing apparatus according to claim 1, further comprising:
a memory device, coupled to the processor and used to store at least one of the testing data, the corresponding data and the at least one product group corresponding to the functional circuits.

3. The testing apparatus according to claim 2, wherein the testing apparatus receives the testing data through an external apparatus and stores the testing data into the memory device.

4. The testing apparatus according to claim 1, wherein the testing data transceiver respectively transports the testing data to the corresponding functional circuits, receives a plurality of testing response data respectively generated in response by the functional circuits according to each of the corresponding testing data and transports the testing response data to the processor.

5. The testing apparatus according to claim 4, wherein the processor determines a level corresponding to each of the functional circuits according to results of the testing data or results of the testing response data and further determines the product group of the at least one electronic apparatus according to the levels of the functional circuits.

6. The testing apparatus according to claim 1, wherein the testing apparatus is embedded in the at least one electronic apparatus.

7. The testing apparatus according to claim 1, wherein the processor emulates the testing data transceiver as an application electronic device of one of the functional circuits through sending a command and performs a test on one of the functional circuits through the emulated testing data transceiver.

8. The testing apparatus according to claim 1, wherein the functional circuits comprise a network transmission circuit, a display interface circuit, an audio interface circuit, a power control circuit, a touch circuit, an image capture circuit, a data storage circuit and a transmission interface circuit.

9. A testing system, comprising:
a plurality of electronic apparatuses, each of the electronic apparatuses having a plurality of functional circuits; and
a testing apparatus, coupled to the electronic apparatuses and comprising:
a testing data transceiver, coupled to a plurality of functional circuits of each of the electronic apparatuses through a plurality of connection interfaces and respectively transporting a plurality of testing data corresponding to the functional circuits for the electronic apparatuses in sequence or parallel for testing the functional circuits to generate a plurality of corresponding data; and
a processor, coupled to the testing data transceiver, transporting the testing data to the testing data transceiver for the testing data transceiver to receive the corresponding data and determining at least one product group of each of the electronic apparatuses and at least one of the functional circuits according to the corresponding data.

10. The testing system according to claim 9, wherein the testing apparatus further comprises:
a memory device, coupled to the processor and used to store at least one of the testing data, the corresponding data and the at least one product group corresponding to the functional circuits.

11. The testing system according to claim 10, wherein the testing apparatus receives the testing data through an external apparatus and stores the testing data into the memory device.

12. The testing system according to claim 9, wherein the testing data transceiver respectively transports the testing data to the functional circuits corresponding to the electronic apparatuses under test, receives a plurality of testing response data respectively generated in response by the functional circuits according to each of the corresponding testing data and returns the testing response data to the processor.

13. The testing system according to claim 12, wherein the processor determines a level corresponding to each of the functional circuits according to the testing data and the testing response data and further determines the product group of the at least one electronic apparatus according to the levels of the functional circuits.

14. The testing system according to claim 9, wherein the processor emulates the testing data transceiver as an application electronic device of one of the functional circuits through sending a command and performs a test on one of the functional circuits through the emulated testing data transceiver.

15. The testing system according to claim 9, wherein the functional circuits comprise a network transmission circuit, a display interface circuit, an audio interface circuit, a power control circuit, a touch circuit, an image capture circuit, a data storage circuit and a transmission interface circuit.

16. A testing method, used to test at least one electronic apparatus, the testing method comprising:
respectively transporting a plurality of testing data corresponding to a plurality of functional circuits of the at least one electronic apparatus for respectively testing the functional circuits to generate a plurality of corresponding data; and
receiving the corresponding data and determining at least one product group of the at least one electronic apparatus and at least one of the functional circuits according to the corresponding data.

17. The testing method according to claim 16, further comprising:
storing at least one of the testing data, the corresponding data and the at least one product group corresponding to the functional circuits in a memory device.

18. The testing method according to claim 17, further comprising:
receiving the testing data through an external apparatus and stores the testing data into the memory device.

19. The testing method according to claim 16, further comprising:
emulating a testing data transceiver as an application electronic device of one of the functional circuits by a processor through sending a command and performs a test on one of the functional circuits through the emulated testing data transceiver.

20. The testing method according to claim 16, wherein the step of determining the at least one product group of the at least one electronic apparatus and the at least one of the functional circuits according to the corresponding data comprises:
determining a level corresponding to each of the functional circuits according to the testing data and the testing response data; and
further determining the product group of the at least one electronic apparatus according to the levels of the functional circuits.
